(19) United States
(12) Patent Application Publication
(10) Pub. No.: US 2024/0109220 A1
(43) Pub. Date: Apr. 4, 2024

(54) Device for separating at least one in particular conveyed surface element, in particular a plastic film or a plastic film composite material, into individual components

(71) Applicant: Jörg von Seggern Maschinenbau GmbH, Oldenburg (DE)

(72) Inventors: Jörg von Seggern, Oldenburg (DE); Klaus von Seggern, Oldenburg (DE)

(21) Appl. No.: 18/478,764

(22) Filed: Sep. 29, 2023

(30) Foreign Application Priority Data
Sep. 30, 2022 (DE) 102022125320.1

(51) Int. Cl. B26F 1/44; B26F 1/40

(52) U.S. Cl. CPC B26F 1/44; B26F 1/40

(57) ABSTRACT

A device for separating at least one conveyed surface element, a plastic film or a plastic film composite material, into individual components, includes at least one punching tool, which has at least one punching beam that operates against an anvil and is held in place by a framework. The punching beam and the framework are connected to one another via a pendulum joint, wherein the pendulum axis of the pendulum joint runs transversely to the longitudinal axis of the punching beam. This device enables a clean separation of the plastic film or plastic film composite material.

### BACKGROUND OF THE INVENTION

### Field of the Invention

The invention relates to a device for separating at least one in particular conveyed surface element, in particular a plastic film or a plastic film composite material, into individual components, having at least one punching tool, which has at least one punching beam that operates against an anvil and is held in place by a framework.

### Description of Related Art

Plastic films or plastic composite materials are used, for example, to produce packaging for food, everyday goods, tools and the like. A plastic film that has been rolled up, for example, is separated into individual components after moulding containers, for example, by thermoforming and filling and sealing the containers.

Abovementioned separating devices are used for this separating work. They comprise at least one punching tool, with which separation of individual components of the plastic film is possible even with fast cycles. Punching tools operate with high forces, which are necessary to achieve safe separation during the crush separation performed by punching.

The problem is that forces are regularly applied to punching tools in a punctiform manner, for example centrally in one point or also in two points, for example at the free ends of a punching tool. As a result of the various forces being applied, high forces occur when the punching beam and anvil are pressed against each other, which can lead to slight bending of the tools involved in the punching process. These bends result in gaps between the punching tools where insufficient punching occurs. Frequent corrections are required; premature wear of the punching tools occurs as a result of additional force application during punching.

The object of the invention is therefore to provide a device of the type mentioned in the introduction, which enables a clean separation of the plastic film or of the plastic film composite material.

This object is achieved according to the invention by virtue of the fact that the punching beam and the framework are connected to one another via a pendulum join, wherein the pendulum axis of the pendulum joint runs transversely to the longitudinal axis of the punching beam.

In the device according to the invention, the punching beam is not held in a rotationally fixed manner in a framework. Instead, the punching beam is supported by a pendulum joint, which enables the punching beam to swivel in relation to the framework in which the punching beam is held.

The pendulum capability firstly ensures that the punching beam can be positioned correctly against the anvil as a counterpart during punching. In addition, the one pendulum joint ensures a central suspension of the punching beam, which enables the punching beam to deflect at its free ends when high forces occur. If corresponding counterforces are applied to the anvil on the outer sides of the anvil, exactly the opposite deflection occurs in the anvil. A depression forms there because the forces are applied to the outer sides. The punching beam and anvil can be placed close together such that the desired clean separation occurs as a result.

The pendulum axis is oriented transversely to the longitudinal axis of the punching beam and thus parallel to a conveying direction of the plastic film or the plastic film composite material.

The punching beam is preferably suspended from the pendulum joint, for which purpose the framework preferably has a receptacle for the pendulum joint.

According to a further embodiment of the invention, it is provided that the receptacle is a transverse support, which is arranged transversely to a conveying direction of the surface element above the surface element. The transverse support is designed like a main beam and is arranged above the plastic film or plastic film composite material to be separated. For this purpose, it is held by the framework, and the transverse support can stand on corresponding stands at its respective free ends. These stands are then arranged on both sides of the conveyed surface element.

A next embodiment of the invention provides that the transverse support is formed from at least three shell elements, wherein the outer shell elements are connected to the framework and wherein the central shell element supports the punching beam and is suspended from the pendulum joint. According to this embodiment, the transverse support is compact. Three identically shaped shell elements can lie congruently on top of one another, the two outer shell elements being fixedly connected to the framework; they hold the central shell element between them via the pendulum joint. The central shell element can thus swing freely between the two outer shell elements, the central shell element supporting the punching beam.

A next embodiment of the invention provides that the central shell element is accommodated in the framework such that its height can be varied. Here, an adaptation to different punching tasks can be made for different surface elements. The height adjustability is preferably guaranteed by an eccentrically formed section of the pendulum joint, which supports the central shell element. The pendulum joint is arranged in the outer shell elements and can be adjusted in its rotational position from the outside, for example, by knurling of its outer edge. The eccentric section is associated with a fixing element for fixing a height position of the shell element in order to fix the height of the pendulum joint for punching tasks.

With regard to the height-adjustable receptacle of the pendulum joint in the framework, one alternative of the invention provides that the pendulum joint is accommodated in a wedge-shaped frame. The pendulum joint can be displaced in such a wedge-shaped frame; a change in the height arrangement of the pendulum joint can be achieved when the orientation of the wedge-shaped frame is changed from a horizontal position and the wedge-shaped frame is displaced.

The wedge-shaped frame is preferably associated with a spindle drive. The spindle drive is attached to the wedge-shaped frame in such a way that when the spindle drive is operated, a change in position of the wedge-shaped frame occurs. In this respect, the position of the wedge-shaped frame can be changed from the outside by a suitable spindle drive. The spindle drive is preferably associated with a fixing member to fix a certain position of the spindle drive and wedge-shaped frame.

### BRIEF DESCRIPTION OF THE DRAWINGS

One exemplary embodiment of the invention is shown in the drawing. In the figures:

FIG. 1: shows a schematic side view of a device for conveying a surface element and for moulding containers, sealing the containers and separating the containers from one another;

FIG. 2: shows a perspective partial view of the containers to be separated;

FIG. 3: shows a perspective view of the device according to the invention for punching the surface element during a punching operation;

FIG. 4: shows a perspective partial sectional view of a component of the device according to the invention;

FIG. 5: shows a side view of the component according to FIG. 4;

FIG. 6: shows a perspective partial sectional view of the component according to FIGS. 4 and 5; and

FIGS. 7 to 9: show perspective partial sectional and side views of an alternative embodiment of a component of the device according to the invention.

### DETAILED DESCRIPTION OF THE INVENTION

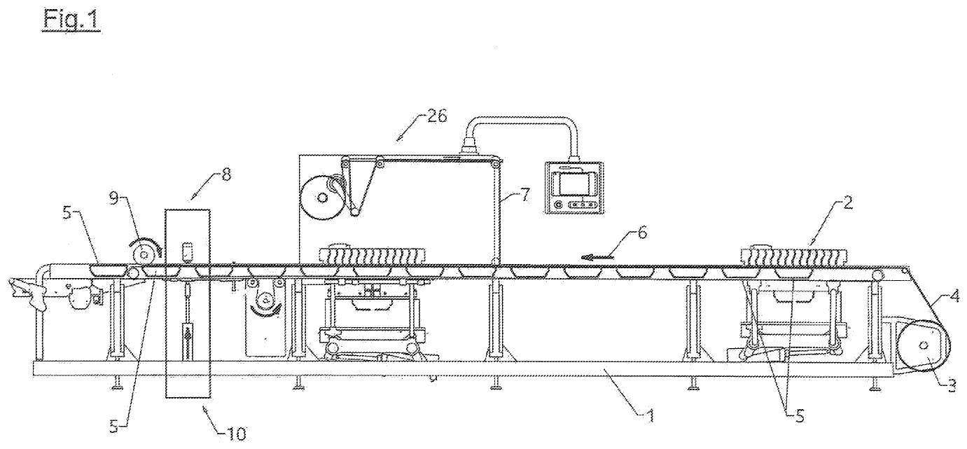

The device in FIG. 1 has a machine frame 1, which supports several workstations. Reference number 2 denotes a thermoforming station. In this, containers 5 are moulded into a surface element 4, in particular a foil strip, unrolled from a roll 3. After the containers 5 have been moulded, the surface element 4 is further transported along arrow 6, for example filled with objects and guided to a sealing station 26. The containers 5 are sealed in this sealing station 26 with a sealing film 7.

The containers 5 are then transported to a cutting station 8. In this cutting station 8, the containers 5 are cut with a rotating blade 9 parallel to the conveying direction of the surface element 4. The cutting transverse to the conveying direction of the surface element 4 is carried out with a punching device 10.

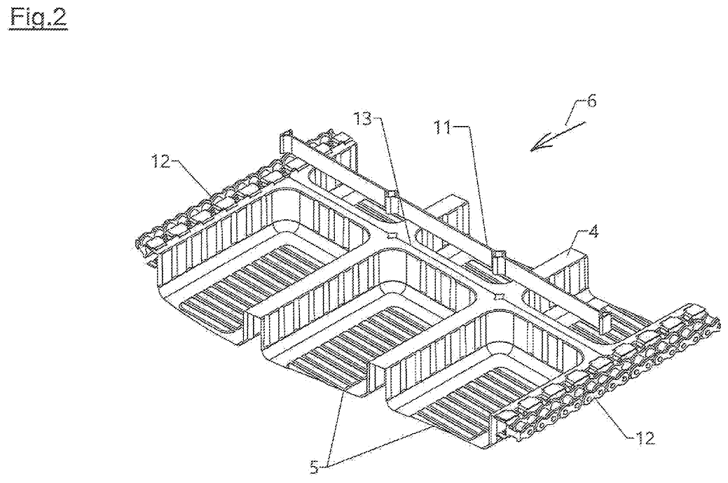

FIG. 2 shows a component of the punching device 10, namely the punching beam 11 of the punching tool. It extends over the entire width of the surface element 4, which is held at its longitudinal edges in chains 12 for its transport. The containers 5 shown in FIG. 2 are to be separated from one another transversely to the conveying direction (arrow 6) of the surface element 4 with the punching device 10. The punching occurs along a line 13.

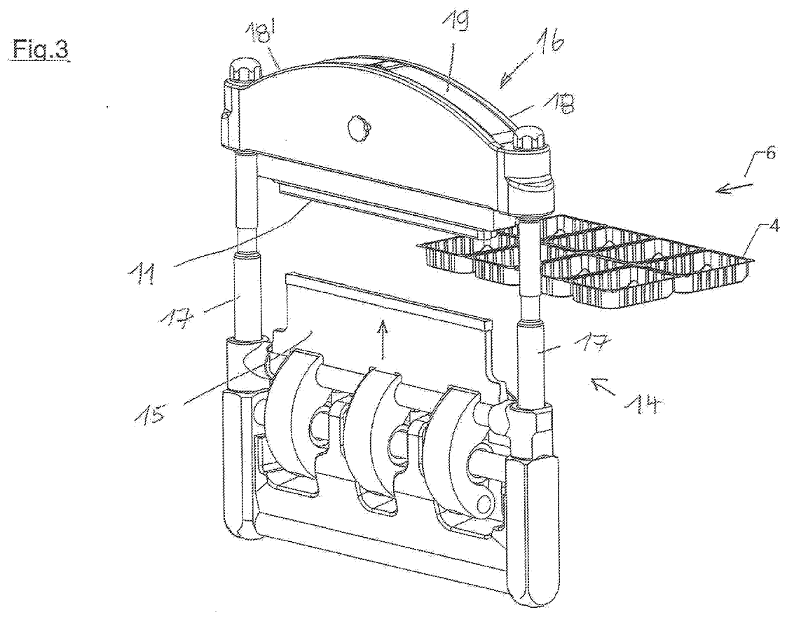

FIG. 3 shows the punching device 10 during a punching operation. A surface element 4, which is fed to the punching device 10 along the conveying direction marked by the arrow 6, is punched. The punching beam 11 shown in FIG. 2 is accommodated in a framework 14. A punching sub-tool 15 is also accommodated in the framework 14.

The framework 14 comprises a transverse support 16 that rests on stands 17. The transverse support 16 is formed from three shell elements 18, 18′ and 19.

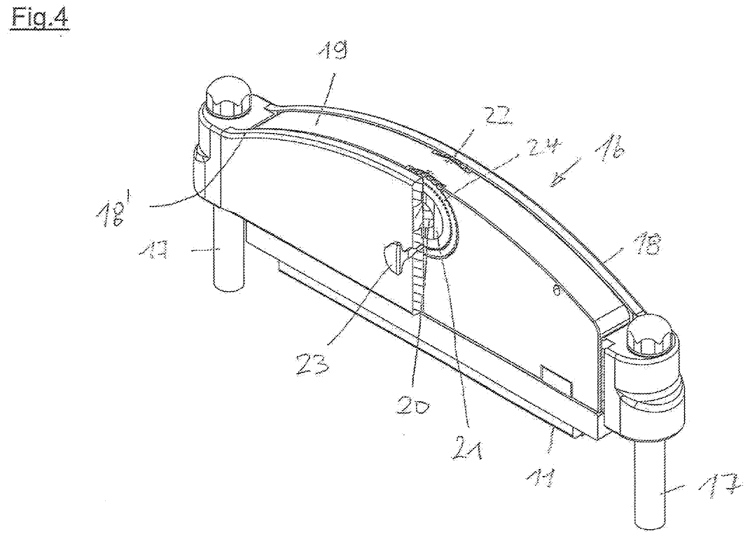

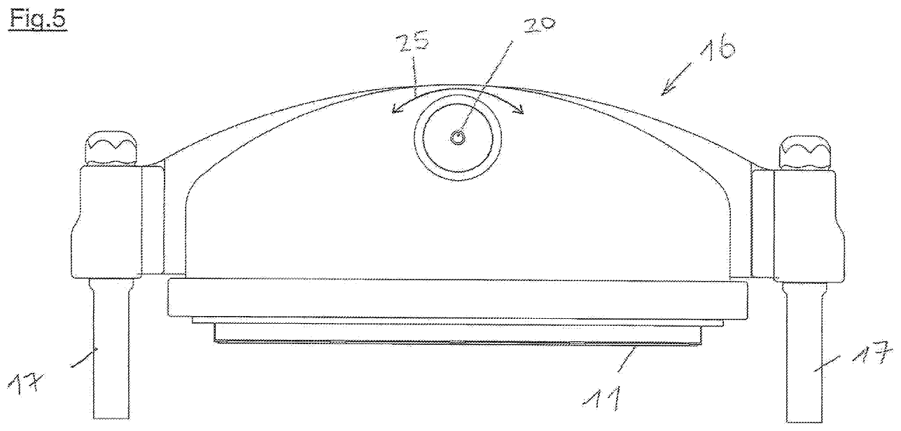

FIGS. 4 and 5 show that the shell element 19 is connected to the shell elements 18 and 18′ via a pendulum joint 20. The shell element 19 can swing within the two outer shell elements 18, 18′, as shown by the double arrow 25 in FIG. 5. The shell element 19 supports the punching beam 11.

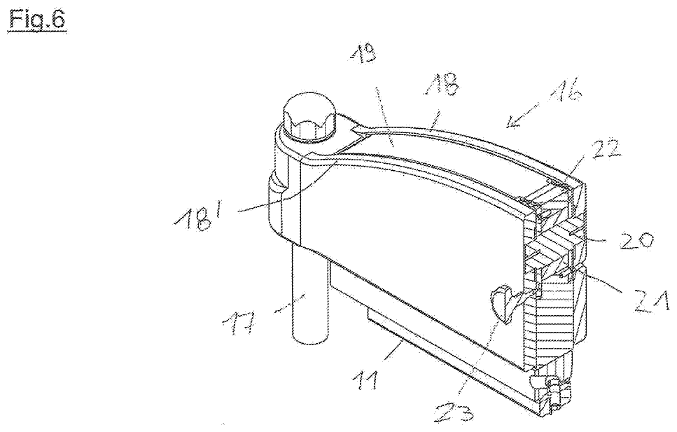

FIGS. 4 and 6 show that the pendulum joint 20 has an eccentric section, which enables the height of the shell element 19 to be adjusted in relation to the shell elements 18, 18′. A disc 21 is arranged on the eccentric section of the pendulum joint 20. This is accommodated in the central shell element 19. Height adjustments can be made via knurled sections 22, a fixing element 23 corresponds to a series of holes 24. The rotational position of the pendulum joint 20 can be fixed with the fixing element 23.

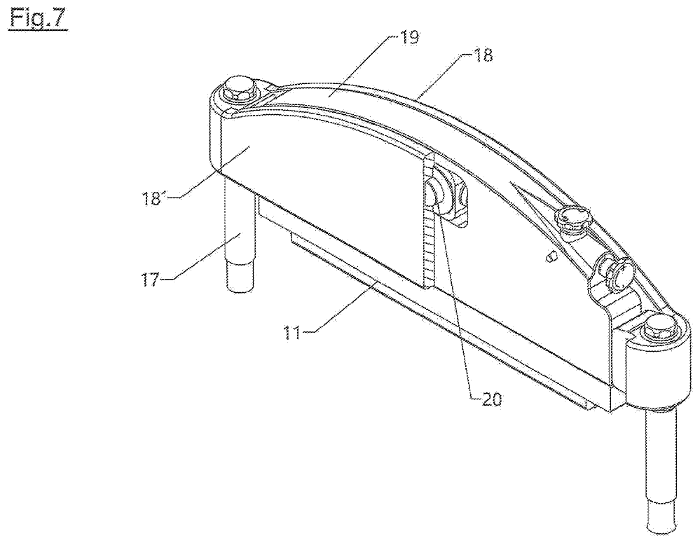

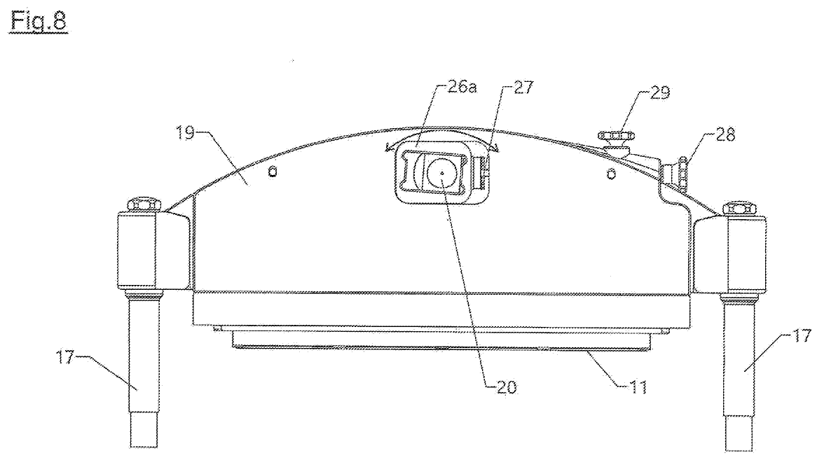

FIGS. 7 and 8 show an alternative embodiment of the shell element 19. The shell element 19 is again connected to the shell element 18 and 18′ via the pendulum joint 20, but an alternative mechanism is provided for adjusting the height of the shell element 19. This alternative mechanism comprises a wedge-shaped frame 26a, which is arranged obliquely to the horizontal. The frame 26a is associated with a spindle drive 27, which is attached to the frame 26a. FIG. 8 directly shows the shell element 19.

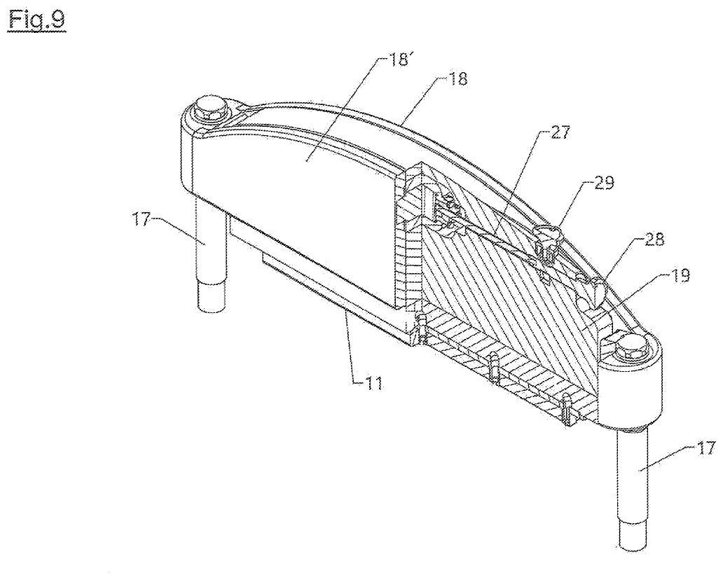

FIG. 9 shows that the spindle drive 27 is guided within the shell element 19 outwards up to a handle 28. Another handle 29 is provided here and is intended to clamp the spindle drive 27.

FIG. 8 shows that the wedge-shaped frame 26a has its wedge shape within a frame cut-out, i.e. on the inside of the frame 26a. Moving this frame 26a adjusts the height of the arrangement of the shell element 19.

1. A device for separating at least one conveyed surface element, a plastic film or a plastic film composite material, into individual components, having at least one punching tool, which has at least one punching beam that operates against an anvil and is held in place by a framework, wherein
the punching beam and the framework are connected to one another via a pendulum joint, wherein the pendulum axis of the pendulum joint runs transversely to the longitudinal axis of the punching beam.

2. The device according to claim 1, wherein the punching beam is suspended from the pendulum joint.

3. The device according to claim 1, wherein the framework has a receptacle for the pendulum joint.

4. The device according to claim 3, wherein the receptacle is a transverse support, which is arranged transversely to a conveying direction of the surface element above the surface element.

5. The device according to claim 4, wherein the transverse support is formed from at least three shell elements, wherein the outer shell elements are connected to the framework and wherein the central shell element supports the punching beam and is suspended from the pendulum joint.

6. The device according to claim 1, wherein the shell element is accommodated in the framework such that its height can be varied.

7. The device according to claims 5, wherein the shell element is accommodated in the framework such that its height can be varied, and wherein the shell element is accommodated in the pendulum joint, wherein the pendulum joint is rotatably accommodated in the outer shell elements and wherein the pendulum joint has an eccentrically formed section in its extension.

8. The device according to claim 7, wherein the eccentric section is associated with at least one fixing element for fixing a height position of the shell element.

9. The device according to claims 5, wherein the shell element is accommodated in the framework such that its height can be varied, and wherein in that the pendulum joint is accommodated in at least one wedge-shaped frame.

10. The device according to claim 9, wherein the wedge-shaped frame is associated with at least one spindle drive.
